(19) United States
(12) Patent Application Publication
(10) Pub. No.: US 2012/0206084 A1
(43) Pub. Date: Aug. 16, 2012

(54) Reserve Power Source for Munitions

(75) Inventor: Jahangir S. Rastegar, Stony Brook, NY (US)

(73) Assignee: OMNITEK PARTNERS LLC, Ronkonkoma, NY (US)

(21) Appl. No.: 13/213,620

(22) Filed: Aug. 19, 2011

Related U.S. Application Data
(63) Continuation-in-part of application No. 13/117,109, filed on May 26, 2011.
(60) Provisional application No. 61/349,184, filed on May 27, 2010.

(51) Int. Cl. H02J 7/00

(52) U.S. Cl. 320/101

(57) ABSTRACT

A method of sustaining a production of power. The method including: initiating a reserve power source of two or more reserve power sources upon a predetermined event; storing at least a portion of a supply of electrical energy from the reserve power source in at least one electrical energy storage device; and repeating the initiating for another reserve power source of the two or more reserve power sources upon determining that the electrical energy stored in the at least one electrical energy storage device is less than a predetermined value.

### CROSS-REFERENCE TO RELATED APPLICATION

This application is a Continuation -In-Part application of U.S. application Ser. No. 13/117,109 filed on May 26, 2011 which claims the benefit of U.S. Provisional Application No. 61/349,184 filed on May 27, 2011, the contents of each of which is incorporated herein by reference.

### BACKGROUND

1. Field

The present invention relates generally to reserve power sources for munitions; and more particularly to compact and integrated thermal battery and storage devices such as capacitors for use in gun-fired munitions, sub-munitions, mortars and the like.

2. Prior Art

Thermal batteries represent a class of reserve batteries that operate at high temperatures. Unlike liquid reserve batteries, in thermal batteries the electrolyte is already in the cells and therefore does not require a distribution mechanism such as spinning The electrolyte is dry, solid and non-conductive, thereby leaving the battery in a non-operational and inert condition. These batteries incorporate pyrotechnic heat sources to melt the electrolyte just prior to use in order to make them electrically conductive and thereby making the battery active. The most common internal pyrotechnic is a blend of Fe and KClO₄. Thermal batteries utilize a molten salt to serve as the electrolyte upon activation. The electrolytes are usually mixtures of alkali-halide salts and are used with the Li(Si)/FeS₂ or Li(Si)/CoS₂ couples. Some batteries also employ anodes of Li(Al) in place of the Li(Si) anodes. Insulation and internal heat sinks are used to maintain the electrolyte in its molten and conductive condition during the time of use. Reserve batteries are inactive and inert when manufactured and become active and begin to produce power only when they are activated.

Thermal batteries have long been used in munitions and other similar applications to provide a relatively large amount of power during a relatively short period of time, mainly during the munitions flight. Thermal batteries have high power density and can provide a large amount of power as long as the electrolyte of the thermal battery stays liquid, thereby conductive. The process of manufacturing thermal batteries is highly labor intensive and requires relatively expensive facilities. Fabrication usually involves costly batch processes, including pressing electrodes and electrolytes into rigid wafers, and assembling batteries by hand. The batteries are encased in a hermetically-sealed metal container that is usually cylindrical in shape. Thermal batteries, however, have the advantage of very long shelf life of up to 20 years that is required for munitions applications.

Thermal batteries generally use some type of igniter to provide a controlled pyrotechnic reaction to produce output gas, flame or hot particles to ignite the heating elements of the thermal battery. Currently, the following two distinct classes of igniters are available for use in thermal batteries.

The first class of igniters operates based on externally provided electrical energy. Such externally powered electrical igniters, however, require an onboard source of electrical energy, such as a battery or other electrical power source with related shelf life and/or complexity and volume requirements to operate and initiate the thermal battery. Currently available electric igniters for thermal batteries require external power source and decision circuitry to identify the launch condition and initiate the pyrotechnic materials, for example by sending an electrical pulse to generate heat in a resistive wire. The electric igniters are generally smaller than the existing inertial igniters, but they require some external power source and decision making circuitry for their operation, which limits their application to larger munitions and those with multiple power sources.

The second class of igniters, commonly called “inertial igniters,” operate based on the firing acceleration. The inertial igniters do not require onboard batteries for their operation and are thereby used often in high-G munitions applications such as in non-spinning gun-fired munitions and mortars. This class of inertial igniters is designed to utilize certain mechanical means to initiate the ignition. Such mechanical means include, for example, the impact pins to initiate a percussion primer or impact or rubbing acting between one or two part pyrotechnic materials. Such mechanical means have been used and are commercially available and other miniaturized versions of them are being developed for thermal battery ignition and the like.

In general, both electrical and inertial igniters, particularly those that are designed to operate at relatively low impact levels, have to be provided with the means for distinguishing events such as accidental drops or explosions in their vicinity from the firing acceleration levels above which they are designed to be activated. This means that safety in terms of prevention of accidental ignition is one of the main concerns in all igniters.

In recent years, new and improved chemistries and manufacturing processes have been developed that promise the development of lower cost and higher performance thermal batteries that could be produced in various shapes and sizes, including their smaller versions. However, since thermal batteries rely on the high temperature to keep the electrolyte in the molten state following initiation, they require a considerable volume of insulation material to prevent the battery from cooling too fast and solidify the electrolyte, thereby very quickly rendering the battery inactive. The need for a considerable amount of insulation around the hot chemicals is a factor that significantly limits the minimum size of thermal batteries, particularly if the thermal battery is required to stay active for relatively long periods of time. These limitations have prevented the development of very small thermal batteries for use in medium and small caliber munitions and sub-munitions, particularly since these munitions spin at very high rates and that in general very high rates are detrimental to the operation of thermal batteries due to the movement of the electrolyte caused by high centrifugal forces.

### SUMMARY

A need therefore exists for reserve power sources for gun-fired munitions, mortars and the like that are inactive prior to launch and become active during or after certain amount of time following launch or other similar acceleration or deceleration event.

In particular, there is a need for small reserve power sources for small and medium caliber munitions that can withstand very high firing accelerations; have very long shelf life, such as beyond 20 years; that can be used in munitions with any spin rate, including very low or no spin to very high spin rate munitions; and that they do not require external power sources to initiate them.

Such reserve power sources are preferably initiated as a result of the round firing using inertial igniters such as those disclosed in U.S. Pat. Nos. 7,587,979 and 7,437,995 or piezoelectric-based inertial igniters such as those disclosed in U.S. Patent Application Publication No. 2008/0129251, each of which are incorporated herein by reference. The inertial igniters, particularly those that can provide relatively long initiation delay, are highly advantageous since by delaying the initiation, the time period in which the molten electrolyte of the thermal battery is subjected to high acceleration/deceleration levels is reduced or even preferably eliminated. The initiation devices to be used must also be capable to operate safely by differentiating all-fire and various no-fire events such as accidental drops and vibration and impact during transportation and loading and even nearby explosions. The task of differentiating all-fire conditions from no-fire conditions is preferably performed without the use of external acceleration sensors and the like, and/or the use of external power sources.

An objective of the present invention is to provide a new type of reserve power source that can be fabricated in small sizes suitable for use in small and medium caliber munitions, sub-munitions and the like. The reserve power sources will use the basic thermal battery or other similar reserve battery technology to generate electrical energy upon activation. The electrical energy is then stored in electrical energy storage devices such as capacitors. The disclosed embodiments allow the fabrication of significantly smaller reserve power sources than currently available thermal batteries.

To ensure safety and reliability, the reserve power source initiator must not initiate during acceleration events which may occur during manufacture, assembly, handling, transport, accidental drops, etc. Additionally, once under the influence of an acceleration profile particular to the firing of the ordinance, i.e., an all-fire condition, the initiator must initiate with high reliability. In many applications, these two requirements compete with respect to acceleration magnitude, but differ greatly in their duration. For example:
An accidental drop may well cause very high acceleration levels—even in some cases higher than the firing of a round from a gun. However, the duration of this accidental acceleration will be short, thereby subjecting the initiator to significantly lower resulting impulse levels.
It is also conceivable that the initiator will experience incidental long-duration acceleration and deceleration cycles, whether accidental or as part of normal handling or vibration during transportation, during which it must be guarded against initiation. Again, the impulse input to the igniter will have a great disparity with that given by the initiation acceleration profile because the magnitude of the incidental long-duration acceleration will be quite low.

The disclosed reserve power sources are preferably provided with hermetically sealed packaging. The disclosed reserve power sources would therefore be capable of readily satisfying most munitions requirement of 20-year shelf life requirement and operation over the military temperature range of −65 to 165 degrees F., while withstanding high G firing accelerations.

Some of the features of the disclosed “reserve power sources” for gun-fired projectiles, mortars, sub-munitions, small rockets and the like include:

1. The disclosed reserve power sources can be fabricated using existing technologies, thereby making them highly cost effective, reliable and very small in size and volume.

2. The disclosed reserve power sources do not require any external power sources for their activation.

3. The novel design of the disclosed reserve power sources allow the packaging of the power sources to withstand very high-G firing accelerations in excess of 50,000 Gs.

In certain applications, the amount of electrical energy that is required is relatively large and therefore makes the size of the capacitor that is required to store the electrical energy that is generated by the thermal battery relatively large. This is particularly the case when the electrical energy is required to be supplied to the electrical energy using device(s), i.e., the electrical load, for a relatively long period of time. In addition, in certain applications, for example for independent powering of one or more circuitry, such as for providing independent power source on each circuit board of a device to eliminate the need for wiring in power to the board or the like, it is also important to make all components of the power source to be relatively small for mounting on a circuit board or the like. This in turn requires that in the case of the disclosed reserve power sources the capacitor component as well as the thermal battery and the initiation components of the power source be very small.

It is noted that the amount of electrical energy that a typical thermal battery can generate requires capacitors or super-capacitors that are orders of magnitude larger in volume than the thermal battery volume. For this reason, to achieve reserve power sources that are small in volume, particularly for applications in different electronics devices such as munitions electronics or other similar devices using the disclosed reserve power sources, it is important to be able to reduce the size of the capacitor or super-capacitor used to store the electrical energy that is provided by the thermal batter.

In addition, since thermal batteries rely on the high temperatures to keep the electrolyte in the molten state following initiation, they require a considerable volume of insulation material to prevent the battery from cooling too fast and solidify the electrolyte, thereby very quickly rendering the battery inactive. The amount of insulation material that can be added has, however, a limit beyond which it will no longer be effective. The length of time over which a thermal battery can be kept active is thereby limited and is orders of magnitude shorter than the length of time that a low-leakage capacitor can be kept charged. As a result, the use of thermal batteries is limited to applications with relatively short operating cycles no matter how effective insulation is used in their construction. This is particularly the case for smaller power sources and in munitions where available volume is highly limited.

The thermal batteries used in the disclosed power sources do not require a significant thermal insulation and in many applications may not require any insulation since the generated electrical energy can be transferred to the capacitors before the molten electrolyte has the time to cool to its solid state. This is generally possible since the cooling (thermal) time constant is generally much longer than those of properly sized dielectric type capacitors (or other fast charging storage devices). As a result, by eliminating or at least minimizing the need for thermal insulation, the resulting reserve power source can be constructed in very small volumes, making them also suitable for application in small and medium caliber munitions and sub-munitions.

A need therefore exists for reserve power sources that can provide relatively large amount of electrical energy over relatively long periods of time, even days, using reserve power sources such as thermal or liquid reserve batteries, without requiring large capacitors or super-capacitors, i.e., capacitors or super-capacitors with enough capacity to store substantially the entire electrical energy that is required to be provided to using device or system.

A need also exist for such reserve power sources to provide the desired amount of electrical energy and power “on demand” and without interruption.

A need also exist for the development of methods of designing such reserve power sources that any reserve power source, whether electrochemically based such as thermal batteries, liquid reserve batteries, “mechanical reserve power sources” as described in U.S. Patent Application No. 2010/0236440, or energy harvesting power sources such as those using piezoelectric elements (e.g., those described in U.S. Pat. Nos. 7,312,557 and 7,701,120 and U.S. Patent Application No. 2009/0160294 and Ser. No. 12/481,550 can be used to provide at least part of the system power source. The contents of U.S. Pat. Nos. 7,312,557 and 7,701,120 and U.S. Patent Application Nos. 2010/0236440, 2009/0160294 and Ser. No. 12/481,550 are incorporated herein by reference.

A need also exists for methods of designing reserve power sources that provide electrical energy using “standard size” thermal or liquid reserve batteries that can then be mass-produced and used to provide the required amount of electrical energy and power, on demand, and over relatively long periods of times, sometimes even many days, thereby making it possible to significantly reduce the cost of such power sources, significantly reduce their overall size and significantly increase the power source run time.

It is appreciated by those of ordinary skill in the art that many different types of capacitors may be used in the disclosed embodiments. However, since it is usually desired to transfer the maximum amount of electrical energy that the thermal battery can generate to the said capacitor(s) of the disclosed embodiments in the shortest possible amount of time, therefore it is preferable to use the so-called super-capacitor or the like for this purpose. Such super-capacitors are usually designed for rapid charging, thereby allow the electrical energy of the thermal battery be rapidly transferred and stored in the said super-capacitors.

In particular, there is a need for small reserve power sources for small and medium caliber munitions that can withstand very high firing accelerations; have very long shelf life, such as beyond 20 years; and that they do not require external power sources to initiate them.

Alternatively, in certain munitions applications or the like, electrical energy is available in the system that employs the present powers sources. If this is the case, then the initial initiation of the present power sources can be made using electrically initiated igniters. It is noted that electrical initiators of various type that require very small amount of electrical energy are available and can be used for this purpose.

An objective of the present invention is to provide a new type of reserve power source that can be fabricated in small sizes suitable for use in small and medium caliber munitions, sub-munitions and the like. The reserve power sources components may be integrated into one single housing or have a distributed configuration, with the latter being particularly suitable for mounting on circuit boards close to the electrical energy consuming devices and components that are intended to utilize the provided electrical energy. The source of electrical energy is several individual thermal batteries or any other type of reserve batteries. At least one of the thermal batteries is first activated when electrical power is to be provided and the electrical energy is stored in at least one capacitor (the electrical energy may also be partly used in the system electrical energy consuming components). Then as the voltage (stored electrical energy) on the capacitor(s) drops below certain predetermined threshold, the next (at least one) thermal battery is activated to similarly provide electrical energy to charge the capacitor (while also providing power to the system electrical energy consuming components). As a result, electrical energy could be made available on demand and for a very long period of time without requiring large capacitors. The disclosed embodiments allow the fabrication of significantly smaller reserve power sources and with run times that are orders of magnitude than is possible with currently available thermal batteries or other reserve power sources.

Another objective of the present invention is provide reserve power sources that provide “power on demand” over long periods of times, even intermittently, as electrical power is desired to be provided to the electrical energy consuming devices or components.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a schematic view of a reserve power source.

FIG. 2 illustrates a sectional view of the reserve power source of FIG. 1.

FIG. 3 illustrates a schematic of a “power on demand” type reserve power source.

### DETAILED DESCRIPTION

In thermal batteries, the electrolyte is solid until it is melted as its temperature is raised as a result of the ignition of the pyrotechnics materials inside the thermal battery or due to other externally provided heat sources, thereby activating the thermal battery. Following activation, a thermal battery stays activated essentially only as long as its electrolyte is in its molten state. For this reason, to keep thermal batteries long enough to provide power over the required length of time, thermal batteries are provided with enough thermal insulation to keep them active during the required period of time, for the case of gun-fired munitions for a few seconds to tens of seconds and even a few minutes. The required layer(s) of insulation material around the thermal battery (chemical) core limits the size (volume) of the thermal battery even when the thermal battery is required to produce minimal electrical energy, for example in the order of a few Joules (J) and even a few hundred milli-Joules (mJ).

In the particular case of gun-fired munitions, sub-munitions and mortars, in particular for their fuzing applications, only a few mJ or at most J of electrical energy is required to be provided by the power source. This power, however, is required to be provided over relatively long periods of time, in some cases a few minutes and usually at least tens of seconds. In applications such as sub-munitions, the electrical power may have to be provided for several minutes to provide for self-destruct and/or disarming capabilities to minimize the probability that sub-munitions become unexploded ordinance (UXO). For the above reasons, thermal batteries must be provided with enough thermal insulation and must be constructed with enough volume that would allow the introduction of enough thermal energy to allow the thermal battery to stay active over the required length of time.

The new method being disclosed provides the means to construct reserve power sources that are based on thermal battery chemistry or the like and its combination with appropriate electrical energy storage devices such as capacitors as an integrated reserve power source. In this method, the thermal battery portion of the reserve power source generates electrical energy upon activation, preferably via an inertial igniter, and the generated electrical energy is rapidly transferred to the electrical energy storage device, preferably a low leakage capacitor. In reserve power sources designed using this method, the thermal battery component of the power source does not require a significant thermal insulation and in many applications may not require any insulation since the generated electrical energy may be transferred to the electrical energy storage device before the molten electrolyte has the time to cool to its solid state. This is generally possible since the cooling (thermal) time constant is generally much longer than those of properly sized electrical storage devices such as capacitors. As a result, by eliminating or at least minimizing the need for thermal insulation, the resulting reserve power source can be constructed in very small volumes, and making them also suitable for application in small and medium caliber munitions and sub-munitions. In addition, since the electrical energy is discharged from the thermal battery chemistry component of the reserve power source very rapidly, very high firing accelerations and spin rate would not have enough time to adversely affect the operation of the thermal battery component of the reserve power source before the desired amount of electrical energy is transferred to the electrical storage device. In addition, the initiation and electrical energy storage components of the reserve power source may be used to provide certain amount of thermal insulation to the hot thermal battery component of the reserve power source.

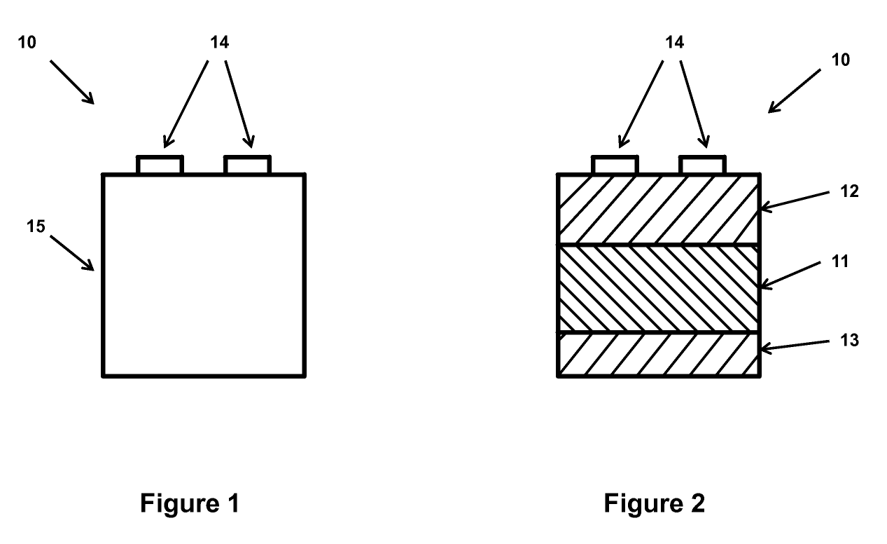

The schematic of the reserve power source embodiment 10 is shown in FIG. 1. As can be seen in FIG. 1, the reserve power source consists of a body 15 and terminals 14. In general, the reserve power source body 15 may have any convenient shape, preferably to match the available space in the munitions.

As shown in the cross-sectional view of FIG. 2, the reserve power source 10 is constructed as an integration of three main components; the thermal battery (chemistry) component 11, the electrical energy storage component 12 (such as at least one capacitor), and the initiation component 13 (preferably inertia based). In addition to the above main components, the reserve power source will also have simple electronics circuits (not shown) for charging the electrical storage component 12. The reserve battery terminals 14, FIG. 1, may in general be located at any convenient location. In addition, the initiation component 13 may be located on the bottom (as shown in FIG. 2), on the top, or at any other convenient location, and can be adjacent to the thermal battery component 11 to minimize the distance that the initiation flame (spark) has to travel to ignite the thermal battery pyrotechnics.

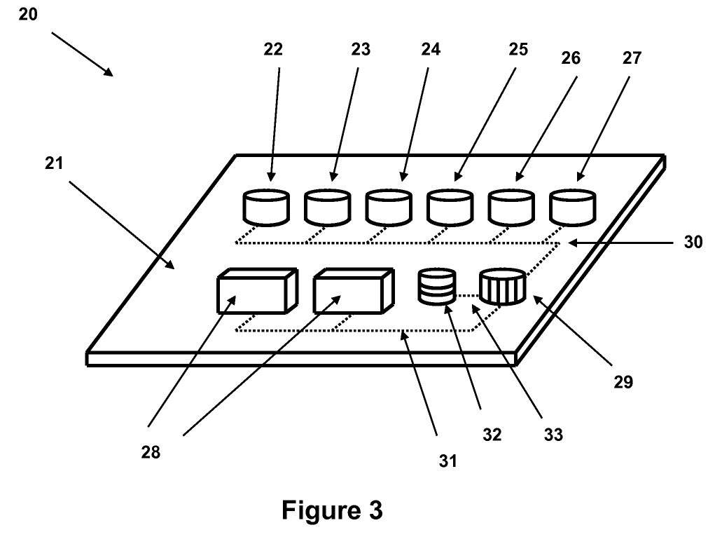

A schematic of a reserve power source embodiment 20 is shown in FIG. 3. The reserve power source is shown to consist of a number of (in general small) thermal batteries (or other types of reserve power sources) 22-27 that are mounted on a base 21 (preferably the circuit board of the power consuming electronics board—when applicable). At least one energy storage device, such as a capacitor (or super-capacitor) 28 is also provided (which can be on the same base 21 as the power source 20). A control unit 29 is also provided, such as on the same base 21 of the power source 20. The control unit 29 is connected to the thermal batteries 22-27 and the capacitor(s) 28 via wirings 30 and 31, respectively. Hereinafter, all aforementioned reserve power source types to be used in the disclosed power source embodiments are referred to as thermal batteries without intending to limit the disclosed power source embodiment to the use of thermal batteries.

In the schematic of FIG. 3, six identically shaped and sized thermal batteries are shown to be provided for the sake of simplicity only. It is, however, appreciated by those skilled in the art that fewer or more thermal batteries (and/or other types of reserve power sources, even “mechanical reserve power sources” of various shapes and sizes and electrical energy capacities may also be used. Similarly, two identically shaped capacitors 28 are shown in the schematic of FIG. 3. However, at least one capacitor (or super-capacitor) or more than two capacitor (or super-capacitor or their combination) of various shapes and capacities may also be used. In addition, one or more (even all) functions of the control unit 29 (to be described later in this disclosure) may be performed by the electrical and electronics components of the system using the power source 20. In addition, one or all components of the power source 20, i.e., one or more of the thermal batteries 22-27, the capacitors (super-capacitors) 28 or the control unit 29 may not be collocated on a single base element 21.

In one embodiment, upon the occurrence of the initial power source activation event, for example upon firing or release of munitions in which the power source is integrated, at least one of the thermal batteries 22-27 is initiated. In gun-fired munitions or mortars, the at least one thermal battery can be initiated as a result of the round firing using inertial igniters such as those disclosed in U.S. Pat. Nos. 7,587,979 and 7,437,995 or piezoelectric-based inertial igniters such as those disclosed in U.S. Patent Application Publication No. 2008/0129251, each of which is incorporated herein by reference. The electrical energy of the activated at least one thermal battery is then used partly (when appropriate) to power the electrical energy consuming elements of the system using the present power source and to charge the at least one capacitor (super-capacitor) 28. The electrical energy stored in the at least one capacitor (super-capacitor) 28 is then available to the electrical energy consuming elements of the system using the present power source until the voltage (electrical energy level) of the capacitor drops below a predetermined threshold as sensed by the control unit 29. At which time, the control unit 29 would initiate at least one other thermal battery 22-27, preferably using one of the various available types of electrical initiators that are commonly used in the initiation of thermal batteries. In this case, electrical energy from the capacitor (super capacitor) can be used to initiate the electrical initiators. The electrical energy of the activated at least one thermal battery is again used partly (when appropriate) to power the electrical energy consuming elements of the system using the present power source and to charge the at least one capacitor (super-capacitor) 28. The process continues as long as electrical energy is needed by the system using the present power source or until the last thermal battery 22-27 is activated and the stored electrical energy in the capacitor (super-capacitor) is consumed by the electrical energy consuming elements of the system.

In another embodiment, an external power generator 32 is provided to supply electrical energy to the control unit 29 via wiring 33. The external power source may be any energy harvesting/scavenging power generators that harvest energy from the environment and stores in the capacitor 28 for initiation of the first thermal battery 22-27, or initiate a thermal battery on demand, intermittently, as an external event/command is detected. Such power sources are particularly suitable for use in systems that are deployed over very long periods of time and that are desired to be activated upon detection of an external event or command. Such systems include, but are not limited to mines, sensory platforms, chemical or biological detection devices, listening devices, probes and the like. The energy harvesting/scavenging power generators 32 may be of thermoelectric type that harvests energy from heat (temperature differential); photoelectric (solar cell) type that harvests energy from light (radiation); piezoelectric type that harvests energy from vibration and/or acoustic noise; Radio Frequency (RF) antennas that harvest energy from RF signals and noise; and the like. It is noted that the power generator 32 is only required to generate a very small amount of electrical energy (to charge one of the capacitors 28—such as a very small and low leakage capacitor or super-capacitor—such as on the order of 2-3 mJ) to power the control unit 29 and initiate a thermal battery, and the aforementioned energy harvesting/scavenging devices have been shown to be capable of providing such small amounts of electrical energy over long enough periods of time.

In another embodiment, the control unit 29 is provided with an event detection sensor (such as an acoustic sensor) or an RF or similar receiver that it uses to either detect a predefined event or receive a coded “wake-up” or other similar message. Then upon detecting the predefined event or receiving the coded message, the control unit 29 initiates at least one thermal battery and powers the device using the power source 20.

Those of skill in the art will appreciate that in the power source 20 of FIG. 3, the size of the capacitors (super-capacitors or their combination) is kept small, thereby making the overall size of the resulting power source very small compared to the size of capacitors needed to store the entire electrical energy of one thermal battery that provides the entire amount of power. Furthermore, those of skill in the art will further appreciate that the power source 20 can use standardize size thermal batteries as needed to provide the desired amount of electrical energy, thereby significantly reducing cost.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method of sustaining a production of power, the method comprising:
(a) initiating a reserve power source of two or more reserve power sources upon a predetermined event;
(b) storing at least a portion of a supply of electrical energy from the reserve power source in at least one electrical energy storage device; and
(c) repeating the initiating for another reserve power source of the two or more reserve power sources upon determining that the electrical energy stored in the at least one electrical energy storage device is less than a predetermined value.

2. The method of claim 1, wherein step (c) is repeated for one or more subsequent reserve power sources until electrical energy is no longer needed.

3. The method of claim 1, wherein the predetermined event is an acceleration having an acceleration profile greater than a predetermined threshold.

4. The method of claim 3, wherein step (a) comprises utilizing an inertial igniter to initiate the reserve power source upon the acceleration profile being greater than the predetermined threshold.

5. The method of claim 3, where step (a) comprises utilizing an energy harvesting power source that generates power upon the acceleration to initiate the reserve power source.

6. The method of claim 1, wherein the predetermined event comprises detecting a wake-up event.

7. The method of claim 6, wherein the detection of the wake-up event comprises detecting a signal.

8. The method of claim 1, wherein a portion of the supply of electrical energy is provided to power consuming elements on board a munitions.

9. A power source comprising:
two or more reserve power sources each of which is capable of producing electrical energy upon initiation;
an initiator corresponding to each of the two or more power sources for initiating a supply of the electrical energy from the two or more power sources;
at least one electrical energy storage device operatively connected to the two or more power sources for storing at least a portion of the electrical energy produced by the two or more reserve power sources; and
a controller configured to:
initiate a first reserve power source of the two or more reserve power sources upon a predetermined event;
store at least the portion of the supply of electrical energy from the first reserve power source in the at least one electrical energy storage device; and
initiate one or more subsequent reserve power sources of the two or more reserve power sources upon a determination that the electrical energy stored in the at least one electrical energy storage device is less than a predetermined value.

10. The power source of claim 9, wherein at least one of the two or more reserve power sources is a thermal battery.

11. The power source of claim 9, wherein the initiator corresponding to the first reserve power source comprises an inertial igniter.

12. The power source of claim 9, wherein the initiator corresponding to the first reserve power source comprises an electrical igniter.

13. The power source of claim 9, wherein the initiators corresponding to the one or more subsequent reserve power sources comprise electrical initiators.

14. The power source of claim 9, wherein the at least one electrical energy storage device comprises a capacitor or super capacitor.

15. The power source of claim 9, further comprising an external power generator for generating power upon a predetermined event and providing power to the initiator corresponding to at least one of the two or more reserve power sources.

16. The power source of claim 9, further comprising a base for affixing one or more of the two or more reserve power sources, initiators, at least one electrical energy storage device and controller.

17. The reserve power source of claim 16, wherein the base comprises a circuit board.

18. The reserve power source of claim 9, wherein the two or more reserve power sources, initiators, at least one electrical energy storage device and controller are provided on an interior of a munitions.
